(19) United States
(12) Patent Application Publication
(10) Pub. No.: US 2026/0131349 A1
(43) Pub. Date: May 14, 2026

(54) COATING DIE HEAD

(71) Applicant: INDUSTRIAL TECHNOLOGY RESEARCH INSTITUTE, Hsinchu (TW)

(72) Inventors: Ping-Yao WU, Zhubei City (TW); Dar-Jen LIU, Taoyuan City (TW); Wen-Bing CHU, Hsinchu City (TW)

(73) Assignee: INDUSTRIAL TECHNOLOGY RESEARCH INSTITUTE, Hsinchu (TW)

(21) Appl. No.: 19/002,296

(22) Filed: Dec. 26, 2024

(30) Foreign Application Priority Data
Nov. 13, 2024 (TW) 113143567

(51) Int. Cl. B05C 5/02

(52) U.S. Cl. CPC B05C 5/0254

(57) ABSTRACT

A coating die head includes an upper die block extending along a first direction and a second direction perpendicular to the second direction, a lower die block and a shim. An extension distance of the upper die block in the first direction is greater than an extension distance of the upper die block in the second direction. The lower die block is disposed under the upper die block. The shim is disposed between the upper die block and the lower die block. A slot gap between the upper die block, the lower die block and the shim forms a manifold. The manifold has a depth in a third direction, and the third direction is perpendicular to the first direction and the second direction. A width of the manifold in the second direction is W, the depth of the manifold in the third direction is DE, and W/DE≥5.

This application claims the benefit of Taiwan application Serial No. 113143567, filed Nov. 13, 2024, the disclosure of which is incorporated by reference herein in its entirety.

### TECHNICAL FIELD

The disclosure relates to a coating die head.

### BACKGROUND

In general, a coating die head includes an upper die block, a lower die block and a shim, and a slot gap between the upper die block, the lower die block and the shim forms a manifold. When coating with slurry containing particles, the current coating die head may have problems with the deposition of slurry particles, so the structure of the coating die head still needs to be further improved.

### SUMMARY

The disclosure is directed to improve a shape of the manifold, to improve a problem of particle sedimentation of a slurry.

According to one embodiment, a coating die head is provided. The coating die head includes an upper die block extending along a first direction and a second direction perpendicular to the second direction, a lower die block and a shim. An extension distance of the upper die block in the first direction is greater than an extension distance of the upper die block in the second direction. The lower die block is disposed under the upper die block. The shim is disposed between the upper die block and the lower die block. A slot gap between the upper die block, the lower die block and the shim forms a manifold. The manifold has a depth in a third direction, and the third direction is perpendicular to the first direction and the second direction. A width of the manifold in the second direction is W, the depth of the manifold in the third direction is DE, and W/DE≥5.

### BRIEF DESCRIPTION OF THE DRAWINGS

FIG. 1 shows an exploded view of a coating die head according to an embodiment of the disclosure.

FIG. 2A shows a perspective view of a coating die head according to another embodiment of the disclosure.

FIG. 2B shows an exploded view of the coating die head of FIG. 2A.

FIG. 3A shows a cross-sectional view of the coating die head of FIG. 1.

FIG. 3B shows a cross-sectional view of a manifold of the coating die head in FIG. 1.

FIG. 3C shows a simulation diagram of the shear rate in the manifold of the coating die head in FIG. 1.

FIG. 3D shows a cross-sectional view of a manifold according to a comparative example of the disclosure.

FIG. 4A shows a cross-sectional view of a coating die head according to another embodiment of the disclosure.

FIG. 4B shows a cross-sectional view of a manifold of the coating die head in FIG. 4A.

FIG. 5A shows a cross-sectional view of a coating die head according to a comparative example of the disclosure.

FIG. 5B shows a simulation diagram of the shear rate in a manifold of the coating die head in FIG. 5A.

FIG. 6 shows a cross-sectional view of a coating die head according to another comparative example of the disclosure.

FIG. 7 shows a cross-sectional view of a coating die head according to a further comparative example of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Various embodiments will be described in more detail below with reference to the accompanying drawings. The narrative content and diagrams are provided for illustration only and are not intended to be limiting. For clarity, some elements and/or symbols may be omitted in some drawings. In addition, elements in the drawings may not be drawn to actual scale. It is contemplated that elements and features in one embodiment can be advantageously incorporated into another embodiment without further description.

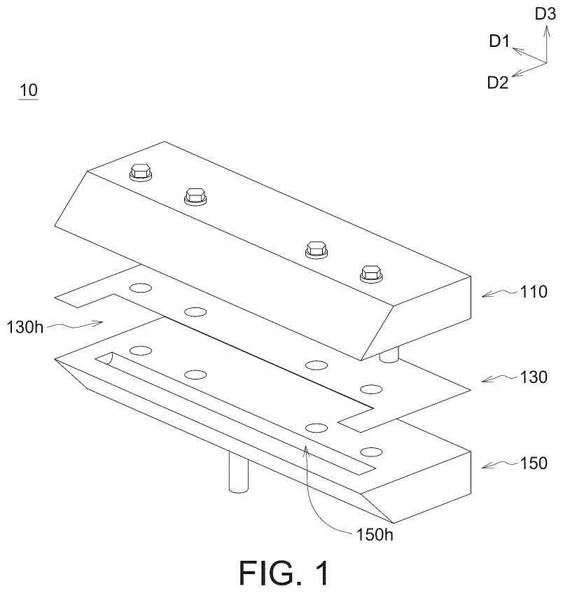

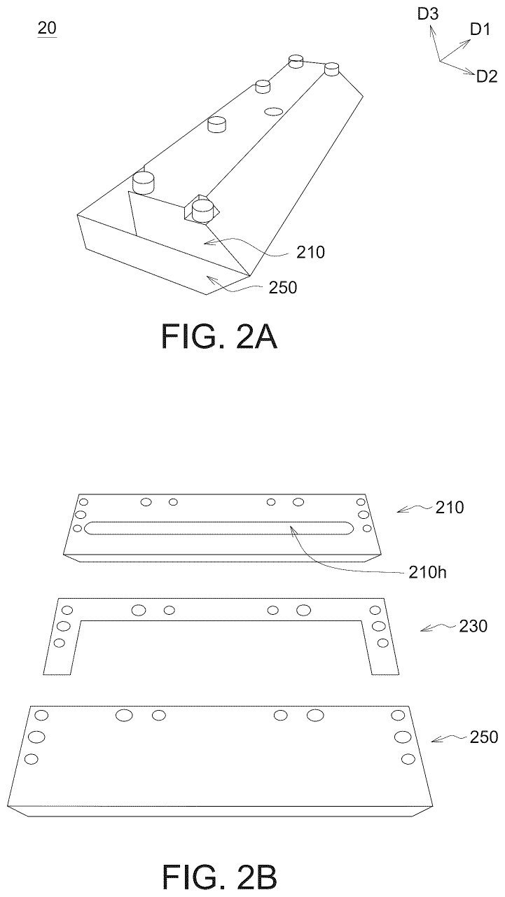

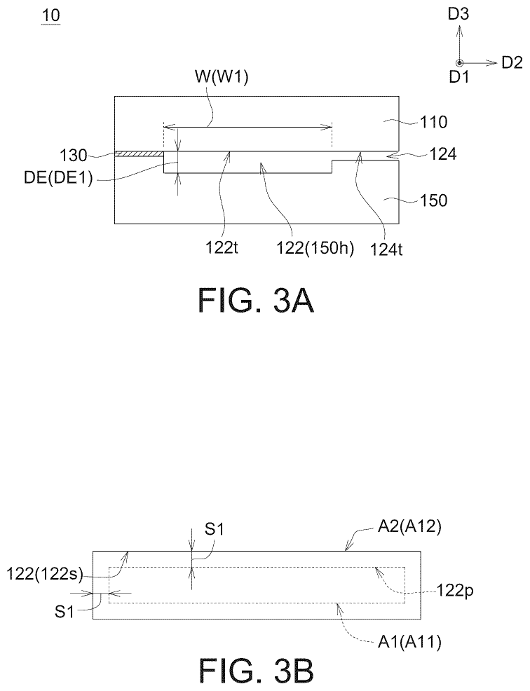

FIG. 1 shows an exploded view of a coating die head 10 according to an embodiment of the disclosure. FIG. 2A shows a perspective view of a coating die head 20 according to another embodiment of the disclosure. FIG. 2B shows an exploded view of the coating die head 20 of FIG. 2A. FIG. 3A shows a cross-sectional view (for example, corresponding to the geometric center of the coating die head 10) of the coating die head 10 of FIG. 1. FIG. 3B shows a cross-sectional view of a manifold 122 of the coating die head 10 of FIG. 1. FIG. 3C shows a simulation diagram of the shear rate in the manifold 122 of the coating die head 10 in FIG. 1. FIG. 3D shows a cross-sectional view of a manifold 622 according to a comparative example of the disclosure.

Referring to FIG. 1, the disclosure provides a coating die head 10. The coating die head 10 includes an upper die block 110, a lower die block 150 and a shim 130. The upper die block 110 extends along a first direction D1 and a second direction D2. The extension distance of the upper die block 110 in the first direction D1 is greater than the extension distance of the upper die block 110 in the second direction D2, and the first direction D1 is perpendicular to the second direction D2. The lower die block 150 is disposed under the upper die block 110. The shim 130 is disposed between the upper die block 110 and the lower die block 150. In the present embodiment, the lower die block 150 includes a groove 150h. The groove 150h is formed on a surface of the lower die block 150 adjacent to the upper die block 110 to allow slurry to flow (detailed below). The upper die block 110 does not include a groove for slurry to flow, but the disclosure is not limited thereto. In other embodiments, as shown in FIGS. 2A and 2B, the lower die block 250 of the coating die head 10 does not include a groove for slurry to flow, while the upper die block 210 includes a groove 210h formed on a surface of the upper die block 210 adjacent to the lower die block 250 for slurry to flow. Similarly, the shim 230 is disposed between the upper die block 210 and the lower die block 250.

As shown in FIGS. 1 and 3A, the slot gap (cavity) between the upper die block 110, the lower die block 150 and the shim 130 forms a manifold 122. That is, the groove 150h in the lower die block 150 corresponds to the manifold 122. In other embodiments, as shown in FIGS. 2A-2B, the groove 210h in the upper die block 210 corresponds to the manifold 122 (not shown).

Please refer to FIGS. 1 and 3A at the same time. The lower die block 150 includes a feed port (not shown) and the groove 150h. The feed port (not shown) and the groove 150h are in communication with each other. The feed port (not shown) is used to provide the coating slurry into the groove 150h. The shim 130 can separate the upper die block 110 and the lower die block 150 with a slit 124. The slit 124 is an outlet for slurry to flow. The shim 130 has an opening 130h, so that the shim 130 has a roughly U-shaped structure as a whole. The opening 130h corresponds to the groove 150h. The opening 130h of the shim 130 is located between the upper die block 110 and the lower die block 150, so that the slot gap between the upper die block 110, the lower die block 150 and the shim 130 further forms a slit 124. The cross-sectional area of the manifold 122 is greater than the cross-sectional area of the slit 124. The width of the opening 130h of the shim 130 in the first direction D1 affects the width of the manifold 122 in the first direction D1, and the depth of the shim 130 in the third direction D3 affects the depth of the slit 124 in the third direction D3. The manifold 122 and the slit 124 are in communication and used to allow the coating slurry to flow. After the slurry enters the manifold 122 from the feed port (not shown), it is discharged through the slit 124, for example, the slurry is coated on the substrate.

As shown in FIG. 3A, the manifold 122 has a depth DE1 in a third direction D3 that is perpendicular to the first direction D1 and the second direction D2. According to some embodiments, the width of the manifold 122 in the second direction D2 is W (W=W1 in the present embodiment), the depth in the third direction D3 is DE (DE=DE1 in the present embodiment), and W/DE≥5. Moreover, the depth DE of the manifold 122 in the third direction D3 is equal to or less than 6 mm (DE≤6 mm). In the present embodiment, a top surface 122t of the manifold 122 is aligned with a top surface 124t of the slit 124, and the depth DE represents the depth of a portion of the manifold 122 that is equal to or less than the height of the top surface 124t in the third direction D3, but the disclosure is not limited thereto.

In the cross-sectional view shown in FIG. 3B, a corresponding cross-sectional area between a tube wall 122s of the manifold 122 and a position 122p which is 1 mm away from the tube wall 122s is A1 (A1=A11 in the present embodiment). That is, the distance S1 between the tube wall 122s and the position 122p is 1 mm. A cross-sectional area corresponding to the tube wall 122s of the manifold 122 is A2 (A2=A12 in the present embodiment), and A1/A2≥36%.

Usually, in order to achieve uniform distribution and stable coating of the coating film, the coating die head has a manifold with a large cross-sectional area and a shim with a small thickness. However, as shown in FIG. 3D, when the slurry flows through the manifold 622 with a large cross-sectional area, if the flow rate of the slurry is too slow, the particles PP in the slurry are easily affected by the gravity GR and sedimentation occurs (for example, particles PP deviates from the original traveling direction MD and is deposited at the bottom of the manifold 622, as shown by the moving path PA of the particles PP). Especially when the particle density in the slurry is higher, the deposition becomes more serious. The phenomenon of particle deposition causes the particle concentration of the slurry flowing through the manifold to change, which causes the uniformity of the coating film at the outlet of the coating die head to change. It is often necessary to shut down the machine to remove the deposited particles, and to make the manifold blocked by particles return to its original state.

Therefore, in order to further improve the situation of particles deposited at the bottom of the manifold, some embodiments of the disclosure improve the shape of the manifold 122 (such as the shape in the cross-sectional view). For example, since the shape of the manifold 122 in the present embodiment is approximately rectangular to meet the following conditions, it can provide a high-shear rate flow channel for the slurry and significantly improve the deposition of slurry particles: A1/A2≥36%, W/DE≥5 and DE≤6 mm.

Please refer to FIG. 3C, which is a contour diagram of simulated shear rate intensity in the manifold 122, in which the unit of the X-axis and the Y-axis are both centimeters (cm). Since the bottom of the manifold 122 still has a high-shear rate (for example, 22.8 to 27.3), the slurry particles are less likely to deposit at the bottom of the manifold 122.

According to the present embodiment, the manifold 122 has an approximately rectangular shape in a cross-sectional view, but the disclosure is not limited thereto. “Approximately rectangular shape” means that the four corners of the rectangle are not necessarily right angles (can be chamfered or otherwise), and the two opposite sides of the rectangle are not necessarily completely parallel straight lines (can be arc lines, slant lines, or other).

According to an embodiment (such as Embodiment 2 in Table 1 below), the width W (i.e., W1) of the manifold 122 in the cross-sectional view (FIG. 3) is 30 mm, the depth DE (i.e., DE1) is 6 mm, and the coating speed of the slurry is 15 m/min, the wet film thickness (that is, the thickness of the coating to the substrate) is 80 μm, the particle size of the particles in the slurry is 10 μm, the density of the particles in the slurry is 4.2 g/cm³, and the viscosity of the slurry is 2,950 cps. It should be understood that the disclosure is not limited thereto. In Embodiment 2, the width-to-depth ratio W/DE of the manifold 122 in the cross-sectional view is 5.00, and the cross-sectional area ratio A1/A2 (i.e., A11/A12) is 37.78%, so it can meet the requirements of A1/A2≥36%, W/DE≥5 and DE≤6 mm, the manifold 122 is a high-shear rate flow channel. Experiments have confirmed that the coating die head 10 according to Embodiment 2 can be continuously produced for 24 hours without shutting down. There is no deposition of slurry particles in the manifold 122. Since the coating slurry is very uniform, the resulting substrate coating film is also quite uniform.

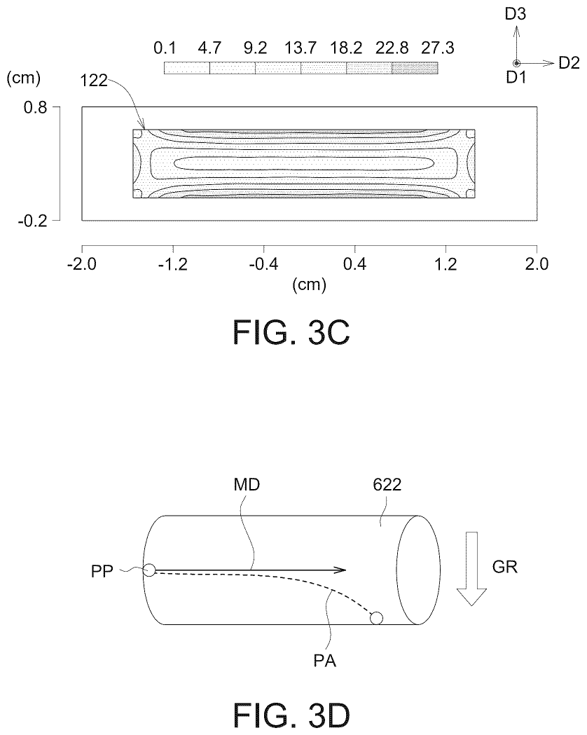

FIG. 4A shows a cross-sectional view (for example, corresponding to the geometric center of the coating die head 10′) of the coating die head 10′ according to another embodiment of the disclosure. FIG. 4B shows a cross-sectional view of the manifold 122′ of the coating die head 10′ of FIG. 4A. FIG. 4A omits the shim 130 from the illustration.

The difference between the coating die head 10′ and the coating die head 10 is that the shape of the manifold 122′ formed by the slot gap between the upper die block 110, the lower die block 150′ and the shim 130 is different from the shape of the manifold 122, and other identical or similar parts will not be described in detail.

According to the present embodiment, the manifold 122′ has an approximately chord-shaped appearance in the cross-sectional view (FIG. 4A), but the disclosure is not limited thereto. In the cross-sectional view of the manifold 122′, the width W in the second direction D2 is equal to W2, the depth DE in the third direction D3 is equal to DE2, and the width-to-depth ratio W2/DE2≥5 and DE2≤6 mm.

Please refer to the cross-sectional view shown in FIG. 4B. The corresponding cross-sectional area between the tube wall 122s′ of the manifold 122′ and the position 122p′ 1 mm away from the tube wall 122s′ is A1 (A1=A11′ in the present embodiment). That is, the distance S1 between the tube wall 122s′ and the position 122p′ is 1 mm. The cross-sectional area corresponding to the tube wall 122s′ of the manifold 122′ is A2 (A2=A12′ in the present embodiment).

According to an embodiment (such as Embodiment 5 in Table 1 below), the width W (i.e., W2) of the manifold 122′ in the cross-sectional view (FIG. 4A) is 30 mm, and the depth DE (i.e., DE2) is 6 mm, the coating speed of the slurry is 9 m/min, the wet film thickness (that is, the thickness of the substrate coating) is 40 μm, the particle size of the particles in the slurry is 1 μm, and the density of the particles in the slurry is 1.2 g/cm³. The viscosity of the slurry is 1,000 cps. It should be understood that the disclosure is not limited thereto. In Embodiment 5, the width-to-depth ratio W/DE (i.e., W2/DE2) of the manifold 122′ in the cross-sectional view is 5.00, and the cross-sectional area ratio A1/A2 (i.e., A11′/A12′) is 46.11%, so Embodiment 5 can meet the conditions of A1/A2≥36%, W/DE≥5 and DE≤6 mm, and the manifold 122′ is a high-shear rate flow channel. Experiments have confirmed that the coating die head 10′ according to Embodiment E can also be produced continuously without shutting down. There is no deposition of slurry particles in the manifold 122′. Since the coating slurry is very uniform, the resulting substrate coating film is also quite uniform.

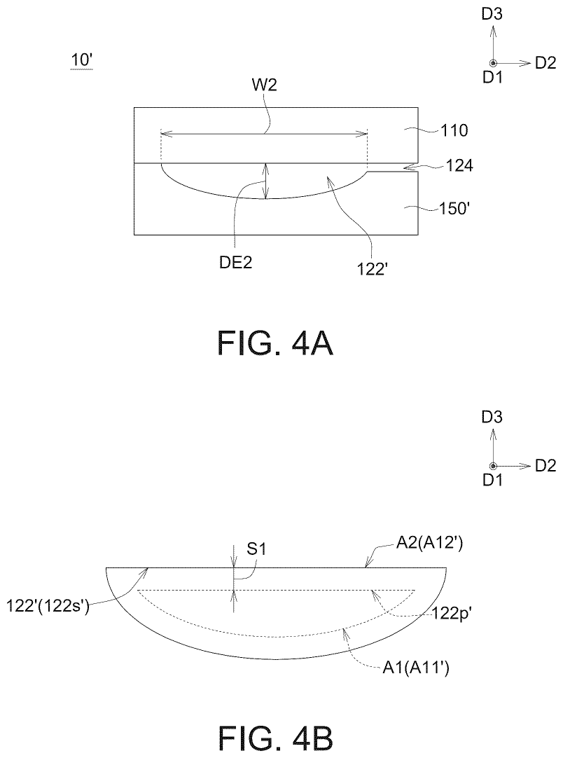

FIG. 5A shows a cross-sectional view (for example, corresponding to the geometric center of the coating die head 30) of the coating die head 30 according to a comparative example of the disclosure. FIG. 5B shows a simulation diagram of the shear rate of the manifold 322 of the coating die head 30 of FIG. 5A, in which the units of the X-axis and the Y-axis are both centimeters (cm). FIG. 5A omits the shim 130 from the illustration.

The difference between the coating die head 30 and the coating die head 10 is that the shape of the manifold 322 formed by the slot gap between the upper die block 110, the lower die block 350 and the shim 130 is different from the shape of the manifold 122, and the other identical or similar parts will not be described in detail.

According to this comparative example, the manifold 322 has an approximately teardrop-shaped appearance in the cross-sectional view (FIG. 5A), and the included angle α of the tip of the teardrop shape is approximately 60°. The width W of the manifold 322 is equal to W3, and the depth DE is equal to DE3.

According to a comparative example (such as Comparative Example 2 in Table 1 below), the width W (i.e., W3) of the manifold 322 in the cross-sectional view (FIG. 5A) is 52.5 mm, and the depth DE (i.e., DE3) is 17.5 mm. The depth DE represents the depth of the portion of the manifold 322 that is equal to or less than the height of the top surface 124t of the slit 124 in the third direction D3, and may correspond to the radius of the teardrop shape. The coating speed of the slurry is 15 m/min, the wet film thickness (that is, the thickness of the substrate coating) is 80 μm, the particle size of the particles in the slurry is 10 μm, and the density of the particles in the slurry is 4.2 g/cm³. The viscosity of the slurry is 2,950 cps. It should be understood that the disclosure is not limited thereto. In Comparative Example 2, the width-to-depth ratio W/DE (i.e., W3/DE3) of the manifold 322 in the cross-sectional view is 1.50, and the cross-sectional area ratio A1/A2 is 21.55%, so Comparative Example 2 does not meet the requirements of A1/A2≥36%, W/DE≥5 and DE≤6 mm, and the manifold 322 does not belong to the high-shear rate flow channel. It has been confirmed through experiments that even though the process conditions of Comparative Example 2 (such as coating speed of slurry, wet film thickness, particle size, particle density and viscosity) are the same as the process conditions of Embodiment 2, because the manifold 322 does not belong to the high-shear rate flow channel, the slurry is prone to have problems of particle deposition. The machine needs to be shut down after 1 hour of use, and then subsequent production can be carried out.

It is also known from the simulation diagram of the shear rate of the manifold 322 in FIG. 5B that the shear rate at the bottom of the manifold 322 is low (for example, 0.72 to 0.89), and particles of slurry are prone to deposit at the bottom of the manifold 322.

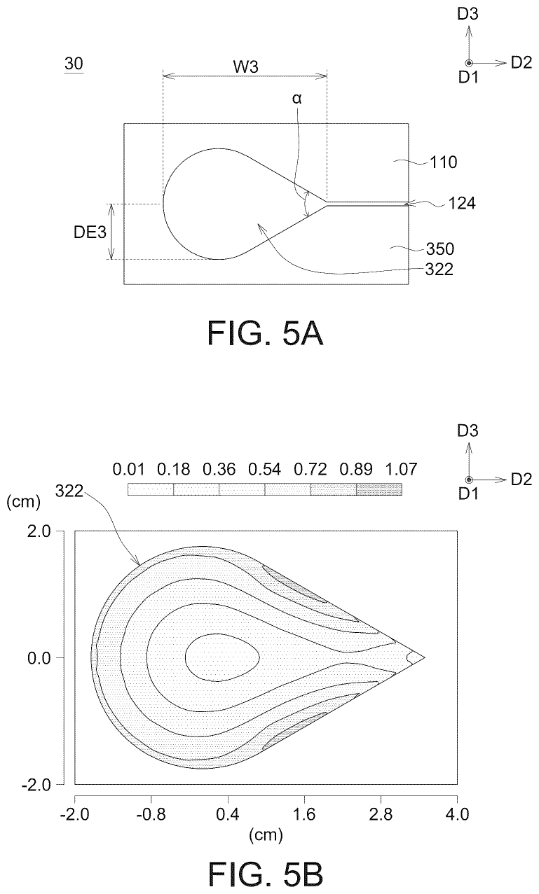

FIG. 6 shows a cross-sectional view (for example, corresponding to the geometric center of the coating die head 30) of the coating die head 40 according to another comparative example of the disclosure, and the shim 130 is omitted.

The difference between the coating die head 40 and the coating die head 10 is that the shape of the manifold 422 formed by the slot gap between the upper die block 110, the lower die block 450 and the shim 130 is different from the shape of the manifold 122, and the other identical or similar parts will not be described in detail.

According to this comparative example, the manifold 422 has an approximately semicircular shape in the cross-sectional view (FIG. 6). The width W of the manifold 422 in the cross-sectional view is equal to W4, and the depth DE is equal to DE4.

According to a comparative example (such as Comparative Example 5 in Table 1 below), the width W (i.e., W4) of the manifold 322 in the cross-sectional view (FIG. 6) is 40 mm, and the depth DE (i.e., DE4) is 20 mm. The depth DE may correspond to the radius of the semicircle. The coating speed of the slurry is 9 m/min, the wet film thickness (that is, the thickness of the substrate coating) is 40 μm, the particle size of the particles in the slurry is 1 μm, and the density of the particles in the slurry is 1.2 g/cm³. The viscosity of the slurry is 1,000 cps. It should be understood that the disclosure is not limited thereto. In Comparative Example 5, the width-to-depth ratio W/DE (i.e., W4/DE4) of the manifold 422 in the cross-sectional view is 2, and the cross-sectional area ratio A1/A2 is 19%, so Comparative Example 5 does not meet the requirements of A1/A2≥36%, W/DE≥5 and DE≤6 mm, and the manifold 422 does not belong to the high-shear rate flow channel. It has been confirmed through experiments that even though the process conditions of Comparative Example 5 (such as coating speed of slurry, wet film thickness, particle size, particle density and viscosity) are the same as the process conditions of Embodiment 5, because the manifold 422 does not belong to the high-shear rate flow channel, the slurry is prone to have problems of particle deposition. After being used for a while, the machine needs to be shut down for solving the problems, and then subsequent production can be carried out.

The following Table 1 lists the cross-sectional conditions (depth DE, width W, width-to-depth ratio W/DE and cross-sectional area ratio A1/A2) of the manifolds according to some comparative examples and embodiments of the disclosure, and the experimental results whether the manifold is a high-shear rate flow channel or not. The difference between the comparative example and the embodiment lies in the shape and size of the manifold, and other identical or similar parts will not be described in detail.

TABLE 1

| | | | | cross- | high- |
|---|---|---|---|---|---|
| | | | width-to- | sectional | shear |
| | Depth | Width | depth | area ratio | rate |
| | DE | W | ratio | A1/A2 | flow |
| group | (mm) | (mm) | W/DE | (%) | channel |
| Comparative | 15 | 45 | 1.50 | 24.89 | No |
| example 1 | | | | | |
| (approximately | | | | | |
| teardrop shape) | | | | | |
| Comparative | 17.5 | 52.5 | 1.50 | 21.55 | No |
| example 2 | | | | | |
| (approximately | | | | | |
| teardrop shape) | | | | | |
| Comparative | 15 | 36.21 | 2.41 | 24.89 | No |
| example 3 | | | | | |
| (approximately | | | | | |
| semi-teardrop | | | | | |
| shape) | | | | | |
| Comparative | 20 | 48.28 | 2.41 | 19.00 | No |
| example 4 | | | | | |
| (approximately | | | | | |
| semi-teardrop | | | | | |
| shape) | | | | | |
| Comparative | 20 | 40 | 2.00 | 19.00 | No |
| example 5 | | | | | |
| (approximately | | | | | |
| semicircular | | | | | |
| shape) | | | | | |
| Comparative | 25 | 50 | 2.00 | 15.36 | No |
| example 6 | | | | | |
| (approximately | | | | | |
| semicircular | | | | | |
| shape) | | | | | |
| Embodiment 1 | 3 | 30 | 10.00 | 68.89 | Yes |
| (approximately | | | | | |
| rectangular | | | | | |
| shape) | | | | | |
| Embodiment 2 | 6 | 30 | 5.00 | 37.78 | Yes |
| (approximately | | | | | |
| rectangular | | | | | |
| shape) | | | | | |
| Embodiment 3 | 3 | 50 | 16.67 | 68.00 | Yes |
| (approximately | | | | | |
| rectangular | | | | | |
| shape) | | | | | |
| Embodiment 4 | 6 | 50 | 8.33 | 36.00 | Yes |
| (approximately | | | | | |
| rectangular | | | | | |
| shape) | | | | | |
| Comparative | 7 | 30 | 4.29 | 33.33 | No |
| example 7 | | | | | |
| (approximately | | | | | |
| rectangular | | | | | |
| shape) | | | | | |
| Comparative | 7 | 50 | 7.14 | 31.43 | No |
| example 8 | | | | | |
| (approximately | | | | | |
| rectangular | | | | | |
| shape) | | | | | |
| Embodiment 5 | 6 | 30 | 5.00 | 46.11 | Yes |
| (approximately | | | | | |
| chord shape) | | | | | |
| Comparative | 7 | 30 | 4.29 | 40.32 | No |
| example 9 | | | | | |
| (approximately | | | | | |
| chord shape) | | | | | |

As shown in Table 1, the manifolds of Comparative Examples 1 and 2 all have an approximately teardrop-shaped appearance in cross-sectional views, for example, the same or similar appearance to the manifold 322 shown in FIG. 5A.

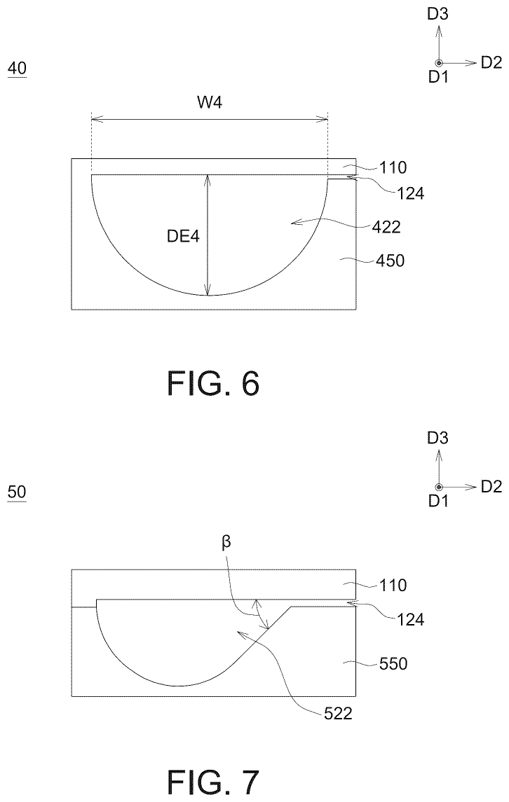

The manifolds of Comparative Examples 3 to 4 all have an approximately semi-teardrop shape in the cross-sectional view, for example, the same or similar appearance to the manifold 522 shown in FIG. 7. Referring to FIG. 7, the coating die head 50 includes an upper die block 110, a lower die 10 block 550 and a shim 130 (not shown), and the slot gap between the upper die block 110, the lower die block 550 and the shim 130 (not shown) forms the manifold 522. The included angle β of the semi-teardrop-shaped tip of the manifold 522 is approximately 45°.

The manifolds of Comparative Examples 5 to 6 all have an approximately semicircular shape in the cross-sectional view, for example, the same or similar shape to the manifold 422 shown in FIG. 6.

The manifolds of Embodiments 1 to 4 and Comparative Examples 7 to 8 all have an approximately rectangular shape in cross-sectional views, for example, the same or similar shape to the manifold 122 shown in FIG. 3A.

The manifolds of Embodiment 5 and Comparative Example 9 both have an approximately chord-shaped appearance in cross-sectional views, for example, the same or similar appearance to the manifold 122′ shown in FIG. 4A.

Since Comparative Examples 1 to 9 do not meet the conditions of A1/A2≥36%, W/DE≥5 and DE≤6 mm, the manifolds are not high-shear rate flow channels, so the bottom of the manifolds is more likely to have particle deposition, and Comparative Examples 1 to 9 are less conducive to the production of a uniform coating film than Embodiments 1 to 5.

Please refer to Embodiment 2 and Comparative Example 7. They have the same width W (30 mm), and the difference in depth DE is only 1 mm. However, even though the cross-section of the manifold in Comparative Example 7 has an approximately rectangular shape, it does not meet the conditions of A1/A2≥36%, W/DE≥5 and DE≤6 mm, so the manifold still does not belong to the high-shear rate flow channel.

Please refer to Example 4 and Comparative Example 8. They have the same width W (50 mm), and the difference in depth DE is only 1 mm. However, even though the cross-section of the manifold in Comparative Example 8 has an approximately rectangular shape and meets the conditions of W/DE≥5, it still does not meet the conditions of A1/A≥36% and DE≤6 mm, so the manifold is still not belongs to a high-shear rate flow channel. Therefore, the significance of the values of A1/A2≥36% and DE≤6 mm plays a key role in the shear rate in the manifold.

However, according to the experimental results, Comparative Example 8 still has less particle sedimentation than Comparative Example 7. It can be seen that meeting the condition of W/DE≥5 can indeed increase the shear rate at the bottom of the manifold, which is helpful for improving the particle sedimentation.

Please refer to Embodiment 5 and Comparative Example 9. They have the same width W (30 mm), and the difference in depth DE is only 1 mm. However, even though the cross-section of the manifold of Comparative Example 9 has an approximately chord-shaped appearance, the width W is the same as the width W of Embodiment 5, and it meets the conditions of A1/A2≥36%, it still does not meet the requirements of W/DE≥5 and DE≤6 mm, so the manifold is still not belong to a high-shear rate flow channel. Therefore, the significance of the values W/DE≥5 and DE≤6 mm plays a key role in the shear rate within the manifold.

In summary, the disclosure provides an improved coating die head. For example, by designing the cross-sectional shape of the manifold of the coating die head (not limited to the above shape) so that it meets at least W/DE≥5, the particle sedimentation of the slurry can be improved. Moreover, when the condition of W/DE≥5 is combined with the condition of A1/A2≥36% and DE≤6 mm, the manifold of the coating die head can be turned into a high-shear rate flow channel. When the manifold becomes a high-shear rate flow channel, the coating liquid (slurry) with dispersed particles can be quickly distributed to achieve uniformity and stably flow out of the coating die head to form a film, which can reduce the residence time of the coating liquid (slurry). The particles in the slurry can be prevented from sedimentation in the manifold due to gravity. Therefore, the coating die head of the disclosure can significantly improve the situation of the slurry particles sedimentation at the bottom of the manifold, allowing the coating die head to be continuously produced without shutting down, greatly improving work efficiency, and the resulting coating slurry is very uniform, and the substrate coatings can have excellent quality.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A coating die head, comprising:
an upper die block extending along a first direction and a second direction, wherein an extension distance of the upper die block in the first direction is greater than an extension distance of the upper die block in the second direction, and the first direction is perpendicular to the second direction;
a lower die block disposed under the upper die block; and
a shim disposed between the upper die block and the lower die block;
wherein a slot gap between the upper die block, the lower die block and the shim forms a manifold, the manifold has a depth in a third direction, and the third direction is perpendicular to the first direction and the second direction;
a width of the manifold in the second direction is W, the depth of the manifold in the third direction is DE, and W/DE≥5.

2. The coating die head according to claim 1, wherein the depth of the manifold in the third direction is equal to or less than 6 mm.

3. The coating die head according to claim 1, wherein, in a cross-sectional view, a cross-sectional area between a tube wall of the manifold and a position 1 mm away from the tube wall is A1, a cross-sectional area of the tube wall of the manifold is A2, and A1/A2≥36%.

4. The coating die head according to claim 1, wherein a groove in the lower die block corresponds to the manifold.

5. The coating die head according to claim 1, wherein a groove in the upper die block corresponds to the manifold.

6. The coating die head according to claim 1, wherein a slot gap between the upper die block, the lower die block and the shim further forms a slit, and the manifold and the slit are in communication with each other; after a slurry enters the manifold, the slurry is discharged through the slit.

7. The coating die head according to claim 6, wherein a cross-sectional area of the manifold is greater than a cross-sectional area of the slit.
